(19) United States
(12) Patent Application Publication
(10) Pub. No.: US 2006/0013848 A1
(43) Pub. Date: Jan. 19, 2006

(54) Polymer with positive charges and the method for forming the same

(75) Inventor: Yen-Hsi Lin, Taipei City (TW)

Correspondence Address: MERCHANT & GOULD PC, P.O. BOX 2903, MINNEAPOLIS, MN, 55402-0903, US

(73) Assignee: TAIWAN TEXTILE RESEARCH INSTITUTE, Tu Chen City (TW)

(21) Appl. No.: 11/007,468

(22) Filed: Dec. 8, 2004

(30) Foreign Application Priority Data
Jul. 16, 2004 (TW) 93121394

(51) Int. Cl. A01N 25/00; C08L 33/18

(52) U.S. Cl. 424/405; 525/230

(57) ABSTRACT

A polymer with positive charges and a method for forming the same are disclosed. The polymer is made from N-substituted alkyl or aromatic 2-(dimethylamino)ethyl acrylate by polymerization. 2-(dimethylamino)-ethyl acrylate and initiators are dissolved in a first solvent and undergo a polymerization reaction. After polymerization, a halide is dissolved in a second solvent to react with the polymer, and then a charged polymer is formed.

### RELATED APPLICATIONS

The present application is based on, and claims priority from, Taiwan Application Serial Number 93121394, filed on Jul. 16, 2004, the disclosure of which is hereby incorporated by reference herein in its entirety.

### BACKGROUND

1. Field of Invention

The present invention relates to a polymer with positive charges and the method for forming the same. More particularly, the present invention relates to quaternary ammonium polymers, which can destroy the cell membrane and the cell wall of microbes for anti-microbial proposes.

2. Description of Related Art

Microorganisms such as bacteria, fungi, and viruses proliferate rapidly and cause various diseases that tend to endanger humans. Anti-microbial agents are added to drinks and foods, sprayed over the environment and in the air, or coated on the surface of clothing and tools to kill microbes.

Quaternary ammonium compounds, chitin, inorganic compounds and natural extracts are commonly used as anti-microbial agents. Quaternary ammonium compounds are widely used because they have no strong smells, have low toxicity, are chemically stable, and effectively destroy microorganisms without causing irritation to the human body.

Quaternary ammonium compounds are cationic surfactants. The quaternary ammonium compounds were found to exhibit anti-microbial activity in 1916 and were described by Domagk et al. in 1935. The anti-microbial mechanism is that quaternary ammonium compounds attach to a microorganism by positive charges of quaternary amino groups and reduce the enzyme activities of membrane proteins. After changing the membrane protein activities, the cell walls and the cell membranes of microorganisms are destroyed, causing the microorganisms to die. Therefore, quaternary ammonium compounds have excellent anti-microbial activity against Gram-positive bacteria, such as Staphylococcus aureaus, as well as anti-Gram negative bacteria, such as Escherichia coli. Furthermore, quaternary ammonium compounds are effective in repressing the proliferation of fungi and lipophilic viruses, such as herpes simplex, influenza and adeno virus.

Quaternary ammonium compounds include organic silicon quaternary ammonium compounds, such as 3-(trimethoxysilyl) propyl dimethyl octadecyl ammonium chloride in U.S. Pat. No. 5,145,596S issued to Dow Corning and claimed compounds in U.S. Pat. No. 5,399,737 issued to Alcon Laboratories and in U.S. Pat. No. 6,613,755 issued to Coating Systems. But the organic siliconic quaternary ammonium compounds described above are small molecules like monomers, dimers or oligomers. Such organic siliconic quaternary ammonium compounds are suitable additives to solutions for environmental antiseptics. If organic siliconic quaternary ammonium compounds with small molecular sizes are coated on the surface of fabrics and goods, the anti-microbial activities of the goods will be totally lost after washing several times.

To overcome the disadvantages described above, a quaternary ammonium polymer has been developed. Poly(4-vinyl-N-hexylpyridiniumbromide) (hexyl-PVP) is a quaternary ammonium polymer which can kill 94-99% of common bacteria (PNAS, 98, 5981-5985, 2001). Hexyl-PVP has the same anti-microbial mechanism as electric shock and does not induce a microorganism's drug resistance. Hexyl-PVP can also provide fabrics and goods with anti-microbial activity by coating or other processes. Unfortunately, raw materials for hexyl-PVP are expensive, increasing the production costs.

For the foregoing reasons, there is a need for a long-term or perpetual anti-microbial agent, which is low cost, nontoxic, and does not induce microorganisms' drug resistance.

### SUMMARY

The present invention relates to charged polymers and their preparation, satisfying the need for an anti-microbial agent, which is low cost, nontoxic, and does not induce microbial drug resistance.

It is therefore an aspect of the present invention to provide nontoxic and charged polymers that contain more charges per unit area.

It is another aspect of the present invention to provide charged polymers that kill microorganisms by electric shock and do not induce drug resistance of microorganisms.

It is still another aspect of the present invention to provide low cost charged polymers. The charged polymers of the present invention provide fabric and plastic ware a long-term anti-microbial effect by immersing, coating or other processes.

It is still another aspect of the present invention to provide a simple continuous method for preparing the charged polymers.

In accordance with the foregoing and other aspects of the present invention, a charged polymer is achieved by polymerizing 2-(dimethylamino)ethyl acrylate and reacting it with an alkyl halide or an aromatic halide after polymerization. The aromatic group or alkyl group reacts with the dimethyl amino group to form a quaternary amino group, providing the nitrogen atom with a positive charge. An anion reacts with the positively charged polymer, resulting in a quaternary ammonium compound. The anion may be chloride, bromide, or iodide.

The present invention further provides a method for preparing the charged polymers. The 2-(dimethylamino)ethyl acrylate monomers and an initiator are dissolved in a first solvent to form a mixed solution. After heating the mixed solution, a polymer is produced by polymerization. A second solvent and a halide are then added to the solution. The halide reacts with the dimethylamino group of the polymers by a substitution reaction, and a charged polymer is achieved.

In the method described above, the 2-(dimethylamino)ethyl acrylate includes 2-(dimethylamino)-ethyl methacrylate (DMAEMA) and the initiator includes azobisisobutyonitrile (AIBN). The first solvent can be toluene, and the second solvent is toluene or N,N-dimethyl formamide (DMF). The halide can be a butyl, hexyl, banzyl or benzoyl chloride, bromide, or iodide, such as bromobutane, bromahexane, benzylchloride, benzoylchloride, or a combination thereof.

Furthermore, the temperature of the polymerization is between about 60 and 65° C., and the temperature of the substitution reaction is between about 85 and 95° C. The polymerization and substitution reactions are allowed to react overnight for completion.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawing as follows:

FIG. 1 is a flow chart illustrating the method for forming the charged polymer of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. All the preferred embodiments are described to make the features and the preparation method of the invention clear.

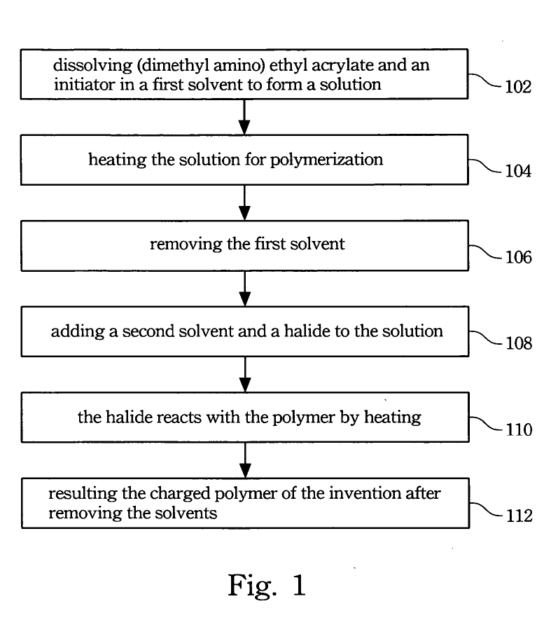

FIG. 1 is a flow chart illustrating process steps for a preparation method in accordance with one example of the invention.

In the first step 102, 2-(dimethylamino)ethyl acrylate monomers and an initiator are dissolved in a first solvent. The 2-(dimethylamino)-ethyl acrylate monomer may be 2-(dimethylamino)-ethyl methacrylate, the first solvent may be toluene, and azobisisobutyonitrile may be used as an initiator. The second step 104 heats the mixture described above to produce a polymer by polymerization. The degree of the polymerization is greater than 3. After polymerization, a selective step 106 is performed for removing the solvent from the mixture.

The step 108 can be performed whether the first solvent is removed or not. In the step 108, a second solvent, such as toluene or N,N-dimethyl formamide, and a halide are added to the mixture. The halide may be alkyl halide or an aromatic halide, such as butyl bromide, hexyl bromide, benzyl chloride, benzoyl chloride, and a combination thereof.

In the step 110, the mixture containing the second solvent and the halide is heated, and then the halide reacts with the polymers by a substitution reaction. After step 112 for removing all solvent in the mixture, a charged polymer of the present invention is obtained. Structure 1A shows the structure of the charged polymer of the present invention.

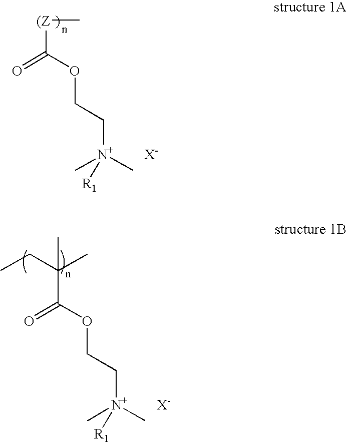

Referring to structure 1A, the symbol Z represents the carbon chain of the acrylate unit. The length of the carbon chain depends on what kind of acrylate monomer is chosen. For example, if 2-(dimethylamino)-ethyl methacrylate is chosen as the monomer for polymerization, the resultant polymer has a structure shown in structure 1B. The symbol n is the degree of polymerization and can be greater than about 3. For example, the polymer will be a three-acrylate-unit polymer when n is 3. R₁ on the side chain of the polymer can be an alkyl group such as butyl and hexyl, or an aromatic group such as benzyl and bezoyl. A quaternary amino group is formed after the R₁ group binding to the dimethyl amino group of the polymer by a substitution reaction. X⁻ represents an anion, which reacts with the positively charged quaternary amino group for forming a quaternary ammonium compound.

Because of the positive charges, the positively charged quaternary ammonium polymer of the present invention may be adsorbed onto the surface of a microorganism, such as a bacterium, fungus or virus, and then destroy the structure of the microorganism's cell wall or cell membrane by electric shock to kill the microorganism.

The following descriptions are several preferred embodiments for understanding the spirit and different variants of the present invention.

### The First Preferred Embodiment

In this embodiment, 99 g 2-(dimethylamino)-ethyl methacrylate and 1.0 g azobisisobutyonitrile are dissolved in 100 g toluene. The solution is stirred and left to react overnight at 65° C. to complete the polymerization. After polymerization, 69.6 g butyl bromide and 800 g N,N-dimethyl formamide are added into the solution. The solution is stirred and left to react overnight at 90° C. to allow a substitution reaction. Poly[2-(butyldimethylamino)-ethyl methacrylate] of the invention is produced after removing all solvent by using a concentrator, such as a cyclotron concentrator. The molecular structure of poly[2-(butyidimethylamino)-ethyl methacrylate] is shown as structure 2A.

### The Second Preferred Embodiment

In the second embodiment, 83 g 2-(dimethylamino)-ethyl methacrylate and 0.9 g azobisisobutyonitrile are dissolved in 100 g toluene. The solution is stirred and left to react overnight at 60° C. to complete the polymerization. After polymerization, 73 g hexyl bromide, 300 g N,N-dimethyl formamide, and 300 g toluene are added into the solution. The solution is stirred and left to react overnight at 95° C. to allow a substitution reaction. Poly[2-(hexyldimethylamino)-ethyl methacrylate] of the invention is produced after removing all solvent by using a concentrator, such as a cyclotron concentrator. The molecular structure of poly[2-(hexyldimethylamino)-ethyl methacrylate] is shown as structure 2B.

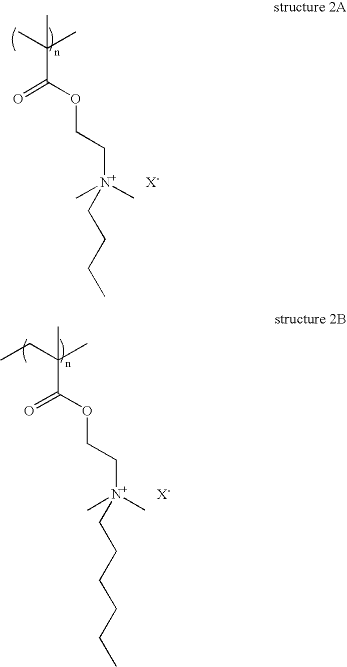

### The Third Preferred Embodiment

In the third embodiment, 83.4 g 2-(dimethylamino)-ethyl methacrylate and 1.0 g azobisisobutyonitrile are dissolved in 100 g toluene. The solution is stirred and left to react overnight at 65° C. to complete the polymerization. After polymerization, 63.8 g benzyl chloride, 300 g N,N-dimethyl formamide, and 300 g toluene are added into the solution. The solution is stirred and left to react overnight at 85° C. to allow a substitution reaction. Poly[2-(benzyldimethyl amino)-ethyl methacrylate] of the invention is produced after removing all solvent by using a concentrator, such as a cyclotron concentrator. The molecular structure of poly[2-(benzyldimethylamino)-ethyl methacrylate] is shown as structure 2C.

### The Fourth Preferred Embodiment

In the fourth embodiment, 86 g 2-(dimethylamino)-ethyl methacrylate and 0.9 g azobisisobutyonitrile are dissolved in 100 g toluene. The solution is stirred and left to react overnight at 65° C. to complete the polymerization. After polymerization, 73 g benzoyl chloride, 300 g N,N-dimethyl formamide, and 300 g toluene are added into the solution. The solution is stirred and left to react overnight at 85° C. to allow a substitution reaction. Poly[2-(benzoyldimethyl amino)-ethyl methacrylate] of the invention is produced after removing all solvent by using a concentrator, such as a cyclotron concentrator. The molecular structure of poly[2-(benzoyldimethylamino)-ethyl methacrylate] is shown as structure 2D. 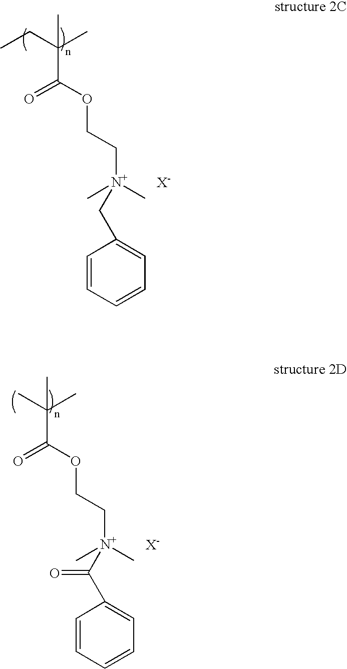
Anti-Bacterial Test

Poly[2-(hexyldimethylamino)-ethyl methacrylate] and poly[2-(benzoyl dimethylamino)-ethyl methacrylate] of the invention were selected for an anti-bacterial test.

Poly (2-(hexyl dimethyl amino)ethyl methacrylate) and poly[2-(benzoyl dimethylamino)ethyl methacrylate] were dissolved in water to obtain 5% (w/w) solutions, respectively. Then, a 1% (w/w) water-soluble acrylate or polyurethane adhesive was added to the solutions. (The concentration of all ingredients of the solution may be changed for the needs of those skilled in the art.) One non-woven fabric was immersed in the solution containing poly [2-(hexyldimethylamino)-ethyl methacrylate], and another was immersed in the solution containing poly[2-(benzoyl dimethyl amino)ethyl methacrylate]. After immersion, the two non-woven fabrics were pressed by a roller with a force of about 1.5 to 2.0 kg/m² and dried at about 110° C. for obtaining anti-microbial non-woven fabrics.

Sample 1 was coated with a product (product No. AEM5700) of Dow Corning. Sample 2 was the non-woven fabric coated with poly[2-(hexyl dimethylamino)-ethyl methacrylate]. Sample 3 was the non-woven fabric coated with poly[2-(hexyldimethylamino)-ethyl methacrylate]. The three samples were tested by the JIS L1902-1998 qualitative method for anti-microbial activities of Staphylococcus aureaus and Escherichia coli. In the test, untreated white cotton fabric was the negative control; and sample 1 treated with the commercial product from Dow Corning was the positive control. The testing results are shown in Table 1.

In the JIS L1902-1998 qualitative method, the test is effective when the seeding concentration of bacteria is 1.0±0.3E5 cell/ml. Ma is the recovering cell number of the untreated white cotton fabric after seeding for 0 hours; Mb is the recovering cell number of the untreated white cotton fabric after seeding for 18 hours; Mc is the recovering cell number of the testing samples after seeding for 18 hours. The proliferation activity of bacteria can be represented by the formula, log(Mb/Ma). The test is effective if the proliferation activity is larger than 1.5. The anti-microbial value is log(Mb/Mc); the pasteurization value is log(Ma/Mc). According to anti-microbial standards of the Japanese Association for the Functional Evaluation of Textiles (JAFET), testing samples are effective to inhibit the proliferation of bacteria if the anti-microbial value is greater than 2.2 and effective to kill bacteria if the pasteurization value is greater than 0.

TABLE 1

| | | Testing results | | | | |
|---|---|---|---|---|---|---|
| | | JIS white | | | | |
| | | cotton | | | | |
| Testing item | | fabric | Sample 1 | Sample 2 | Sample 3 | Testing method |
| Staphylococcus | Seeding | 1.30E+05 | 1.30E+05 | 1.30E+05 | 1.30E+05 | JIS L1902-1998 |
| aureaus | concentration | | | | | Qualitative |
| AATCC 6538P | Ma | 2.59E+04 | — | — | — | Method |
| | Mb | 9.55E+06 | — | — | — | |
| | Mc | — | <20 | <20 | <20 | |
| | Proliferation | 2.57 | — | — | — | |
| | activity | | | | | |
| | Antimicrobial | — | >5.68 | >5.68 | >5.68 | |
| | value | | | | | |
| | Pasteurization | — | >3.11 | >3.11 | >3.11 | |
| | value | | | | | |
| Escherichia coli | Seeding | 1.28E+05 | 1.28E+05 | 1.28E+05 | 1.28E+05 | JIS L1902-1998 |
| AATCC 8739 | concentration | | | | | Qualitative |
| | Ma | 2.57E+04 | — | — | — | Method |
| | Mb | 2.65E+07 | — | — | — | |
| | Mc | — | <20 | <20 | <20 | |
| | Proliferation | 3.01 | — | — | — | |
| | activity | | | | | |
| | Antimicrobial | — | >6.12 | >6.12 | >6.12 | |
| | value | | | | | |
| | Pasteurization | — | >3.11 | >3.11 | >3.11 | |
| | value | | | | | |

According to data in Table 1, each of the two charged polymers of the present invention has an anti-microbial value greater than 5.68 and a pasteurization value greater than 3.11. The testing results show that the charged polymer of the invention is effective to repress and kill Staphylococcus aureaus. The charged polymer of the invention also has the same effect on Escherichia coli.

According to the results of the anti-bacterial test, there are several advantages of the present invention.

One advantage is the anti-microbial activity by perpetual positive charges of the charged polymer of the invention. The positively charged polymers attach to the surface of the microorganisms to reduce the activities of proteins on the bacterial surface. The positively charged polymers of the invention further destroy the cell wall and cell membrane to kill microorganisms by strong electric shock. Such an anti-microbial mechanism as described above will not lead to the microorganisms' drug resistance.

Another advantage is that each molecule of the charged polymers contains more charges per unit area than a conventional anti-microbial molecule with small molecular weight. Therefore, the charged polymers of the present invention are dramatically more effective for anti-microbial purposes.

Still another advantage is that the production cost of the present invention can be reduced by using cheap raw materials.

Still another advantage is the simple continuous production method of the invention.

A further advantage is the perpetual anti-microbial activity of the invention. The charged polymers of the invention can endure on fabrics and plastic goods with long-term or perpetual anti-microbial activity by coating, adding to the raw materials of the fabrics or plastic goods, or by other processes. The fabrics coated with the charged polymer of the invention can be effective to resist the proliferation of microorganisms even after washing several times.

In summary, the charged polymers of the present invention are cheap, easy to produce, do not induce microorganisms' drug resistance, and provide long-term anti-microbial activity.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A polymer comprises a plurality of 2-(alkyldimethylammonium)-ethyl acrylate units by polymerization, wherein the alkyl group has more than one carbon atom.

2. The polymer of claim 1, wherein the 2-(alkyldimethylammonium)-ethyl acrylates comprise (alkyl dimethylamino)ethyl methacrylate.

3. The polymer of claim 1, wherein a degree of polymerization is greater than about 3.

4. The polymer of claim 1, wherein the dimethylethyl group and the alkyl group are in the form of a quaternary amino group.

5. The polymer of claim 1 comprises an anion.

6. The anion of claim 5 comprises a halogen ion.

7. The halogen ion of claim 6 is chloride, bromide or iodide.

8. A charged polymer comprises a plurality of 2-(aromatic dimethylammonium)-ethyl acrylate units by polymerization, wherein the aromatic group is a benyl group or a benzoyl group.

9. The polymer of claim 8, wherein the 2-(aromatic dimethylammonium)-ethyl acrylate comprises 2-(aromatic dimethylammonium)-ethyl methacrylate.

10. The polymer of claim 8, wherein a degree of polymerization is greater than about 3.

11. The polymer of claim 8, wherein the dimethylethyl group and the aromatic group are in the form of a quaternary amino group.

12. The polymer of claim 8 comprises an anion.

13. The anion of claim 12 comprises a halogen ion.

14. The halogen ion of claim 13 is chloride, bromide, or iodide.

15. A method for forming a polymer with charges comprising:
dissolving 2-(alkyl dimethylammonium)ethyl acrylate monomers and an initiator in a first solvent to form a solution;
heating the solution for polymerization;
adding a halide and a second solvent into the solution; and heating the solution containing the halide and the second solvent to form a polymer with charges by a substitution reaction.

16. The method of claim 15, wherein the initiator comprises azobisisobutyonitrile.

17. The method of claim 15, wherein the first solvent comprises toluene.

18. The method of claim 15, wherein a temperature of the polymerization is higher than about 60° C.

19. The method of claim 18, wherein a temperature of the polymerization is in a range of about 60° C. to about 65° C.

20. The method of claim 15, wherein a selective solvent removing step is between the step of polymerization and the step of adding halide and the second solvent into the solution.

21. The method of claim 15, wherein the second solvent is toluene, N-N-dimethyl formamide, or a combination thereof.

22. The method of claim 15, wherein the halide is selected from the group consisting of butyl bromide, hexyl bromide, benzyl, benzyl chloride, benzoyl chloride, and any combination thereof.

23. The method of claim 15, wherein a temperature of the substitution reaction is in a range of about 85° C. to about 95° C.

24. The method of claim 15, wherein a solvent removing step is selectively performed after the substitution reaction.
